(19) United States
(12) Patent Application Publication
(10) Pub. No.: US 2009/0284183 A1
(43) Pub. Date: Nov. 19, 2009

(54) CFL Auto Shutoff for Improper Use Condition

(75) Inventor: Kamran Faterioun, New Berlin, WI (US)

Correspondence Address: S.C. JOHNSON & SON, INC., 1525 HOWE STREET, RACINE, WI, 53403-2236, US

(73) Assignee: S.C. JOHNSON & SON, INC., Racine, WI (US)

(21) Appl. No.: 12/121,456

(22) Filed: May 15, 2008

(51) Int. Cl. H05B 41/36

(52) U.S. Cl. 315/309

(57) ABSTRACT

An auto shutoff mechanism that automatically turns off power to a compact fluorescent lamp (CFL) in the presence of an improper use, or an excessive temperature condition, is disclosed. The auto shutoff includes a temperature transducer, a temperature monitoring circuit, or a microprocessor with memory, and a supporting control circuit. The temperature monitoring circuit, or a predetermined algorithm stored in memory, monitors the ambient temperature for an excessive temperature condition. Upon detection of an excessive temperature condition, the temperature monitoring circuit instructs the control circuit to turn off power to the CFL. Once the detected temperature falls below a predetermined level, power is restored to the CFL.

### TECHNICAL FIELD

Auto shutoff mechanisms for compact fluorescent lamps (CFLs) are disclosed. More particularly, a mechanism that automatically turns off power to a CFL in the presence of an over-temperature condition within the CFL enclosure is disclosed.

### BACKGROUND

Compact fluorescent lamps (CFLs), or fluorescent lamps designed to replace standard incandescent lamps, are well known in the art. CFLs provide a coiled or a compact gas-filled tube associated with a ballast to be inserted into common lamp fixtures designed for incandescent lamps. In contrast to incandescent lamps, CFLs pass electrical current through a gas-filled tube to emit ultraviolet light. The ultraviolet light excites a phosphor coating along the interior of the gas-filled tube to emit white illumination light. Although more complex in design, CFLs are often preferred over incandescent lamps for a number of reasons.

First, CFLs provide illumination light comparable to light emitted from incandescent lamps while consuming only a fraction of the power. Second, the lifespan of a CFL greatly exceeds that of a standard incandescent lamp. However, these additional benefits also come with some substantial risks and/or disadvantages.

A significant percentage of CFLs have been observed to overheat, thus causing the CFLs to fail prematurely, smoke and/or cause damage to the CFL itself and its surroundings. Although some over-temperature conditions within a CFL enclosure may be caused by manufacturing defects, there are still significantly many CFLs that overheat due to improper use and/or installation. In general, CFLs are more likely to overheat if installed in a fixture with inadequate ventilation, or when certain parts of the CFL are exposed to oxygen. Any break in the vacuum seal or the gas-filled tube in a CFL may cause the CFL to fail. For instance, if the CFL is screwed into a lamp fixture by twisting the gas-filled tube rather than the plastic base, the vacuum seal may break and cause damage to the CFL. Breakage of a CFL can be dangerous because of their mercury content in addition to the dangers associated with broken glass.

Currently, all CFLs are designed to meet the UL935 standard which requires the components of CFLs to be self-extinguishing and inflammable. However, UL935 does not preclude CFLs from overheating, smoking and causing damage to surroundings. As a result, a number of solutions have been proposed in an effort to minimize over-temperature conditions. While such solutions may prevent some of the failures associated with overheating, they have their drawbacks.

For instance, some solutions propose the use of housing and related fixtures ventilated specifically for CFLs. This defeats one of the main purposes of CFLs in that it requires the consumer to purchase additional fixtures designed for CFLs and/or to replace older fixtures designed for incandescent lamps. Alternative solutions call for over-current and over-temperature protection (OTP) circuits. An OTP circuit typically uses a bimetal switch to shut a CFL off when the internal temperature of the CFL exceeds an upper limit. However, such a circuit tends to be limited in accuracy with a relatively short sensing range, and has low vibration tolerance. Furthermore, once the OTP circuit has been tripped, it must be reset manually.

Therefore, multiple needs exist for a mechanism for shutting off power to a CFL in improper use conditions that minimizes damage to the CFL and its surroundings, maximizes the life of the CFL, minimizes the need for maintenance, provides fully automated and robust over-temperature protection, and does not require consumers to purchase additional fixtures made specifically for CFLs.

### SUMMARY OF THE DISCLOSURE

In accordance with one aspect of the disclosure, an auto shutoff for a CFL in improper use conditions is provided which comprises an internal thermocouple disposed within a CFL enclosure, a temperature monitoring circuit linked to the thermocouple, and a supporting control circuit linked to the monitoring circuit.

In a refinement, the temperature monitoring circuit is an application specific integrated circuit. In related refinements, the temperature monitoring circuit is a microcontroller or a microprocessor.

In another refinement, the temperature monitoring circuit causes the control circuit to shut off the CFL when a temperature detected by the thermocouple exceeds a first predetermined temperature, and causes the control circuit to restore power to the CFL when a temperature detected by the thermocouple is less than a second predetermined temperature.

In another refinement, the control circuit is linked to the ballast of the CFL.

In accordance with another aspect of the disclosure, an auto shutoff for a CFL comprises an internal temperature transducer disposed within a CFL enclosure, a microprocessor linked to the temperature transducer, and a control circuit linked to the microprocessor. The microprocessor comprises a memory wherein algorithm is stored.

In a refinement, the temperature transducer is external to the microprocessor. In a related refinement, the temperature transducer is a thermocouple.

In another refinement, the algorithm is capable of automatically turning the CFL off when it gets too hot and restoring power to the CFL when the temperature reaches an acceptable level. For example, the algorithm may cause the microprocessor and control circuit to automatically shut off the CFL when the temperature detected by the transducer exceeds a first predetermined level. The algorithm may also cause the microprocessor and the control circuit to automatically turn on the CFL, or provide power to the ballast, when the temperature detected by the transducer falls below a second predetermined level. The second predetermined level may be less than the first predetermined level to provide for a sufficient cooling off.

In yet another refinement, the control circuit includes at least one audible alarm. In a related refinement, the control circuit includes a voltage converter. In another refinement, the control circuit is linked to the ballast of the CFL.

In accordance with another aspect of the disclosure, an auto shutoff for a CFL in improper use conditions is provided which comprises an internal temperature transducer disposed within a CFL enclosure, and a microprocessor linked to a control circuit. The microprocessor comprises a memory wherein algorithm is stored. The algorithm is capable of automatically shutting off the CFL when it gets too hot.

In a refinement, the temperature transducer is a thermocouple. In another refinement, the temperature transducer is internal to the microprocessor and measures the microprocessor die temperature.

In another refinement, the algorithm is further capable of automatically restoring power to the CFL in stable conditions.

In yet another refinement, the control circuit includes a voltage converter and linked to the ballast of the CFL.

These and other aspects of this disclosure will become more readily apparent upon reading the following detailed description when taken in conjunction with the accompanying drawings.

### BRIEF DESCRIPTION OF THE DRAWINGS

FIG. 1A is a diagrammatic sectional view of an exemplary auto shutoff disposed in a CFL enclosure constructed in accordance with this disclosure;

FIG. 1B is a schematic diagram of a disclosed CFL auto shutoff;

FIG. 2A is a diagrammatic sectional view of another auto shutoff disposed in a CFL enclosure;

FIG. 2B is a schematic diagram of another CFL auto shutoff;

FIG. 3 is a circuit diagram of a disclosed CFL auto shutoff; and

FIGS. 4A and 4B are schematic diagrams of exemplary algorithms for operating a disclosed auto shutoff employing a microprocessor.

It will be understood that the teachings of the disclosure can be used to construct CFL auto shutoffs and related mechanisms above and beyond those specifically disclosed in the drawings and described below. One of ordinary skill in the art will readily understand that the specific illustrated embodiments are exemplary in nature.

### DETAILED DESCRIPTION OF THE PRESENTLY PREFERRED EMBODIMENTS

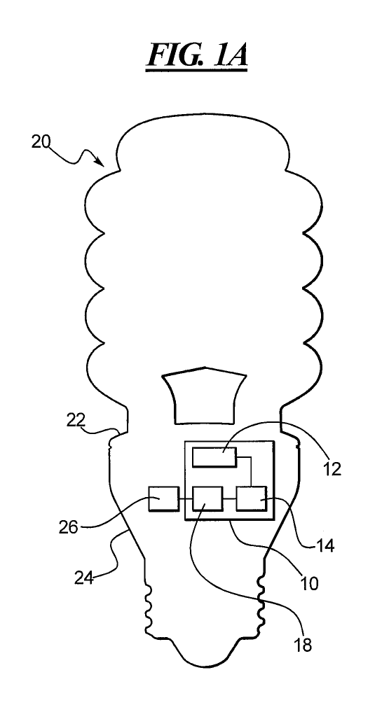

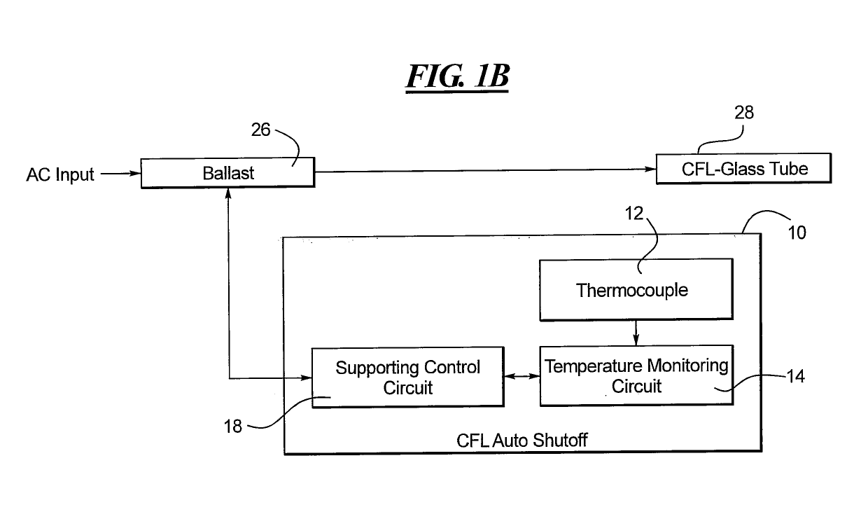

As shown in FIG. 1A, an exemplary auto shutoff 10 is provided for detecting improper use conditions within a typical CFL 20. The auto shutoff 10 may be disposed within an enclosure of the CFL 20 defined by a top 22 and a base 24. Within the enclosure, the auto shutoff 10 may be electrically associated with a ballast 26 responsible for controlling the CFL 20. The auto shutoff 10 of FIG. 1A may include a temperature transducer 12, a temperature monitoring circuit 14, and a supporting control circuit 18. The temperature transducer 12 may include a thermistor, a pyroelectric material, a thermocouple, a resistance temperature detector (RTD), or any other temperature sensor. The temperature monitoring circuit 14 may include a microcontroller, microprocessor, application specific integrated circuit (ASIC), field programmable gate array (FPGA), or any other circuit configured to monitor and respond to changes in temperature.

Referring to FIGS. 1A and 1B, a temperature transducer, or thermocouple 12, may be used to measure the internal temperature of the CFL 20 and continuously transmit the information to the temperature monitoring circuit 14. Upon detection of an over-temperature condition, the monitoring circuit 14 may respond by outputting a specific signal, voltage and/or current, to the supporting control circuit 18, which in turn shuts off power to the CFL 20. Specifically, the monitoring circuit 14 and the supporting control circuit 18 may execute the shutoff by disabling the output of the ballast 26, or by any other means of disabling power to the CFL 20. Once the CFL 20 has been turned off, the monitoring circuit 14 may continue to read temperature measurements provided by the thermocouple 12. If the ambient temperature returns to stable conditions, the monitoring circuit 14 may subsequently output the necessary voltage and/or current to the supporting control circuit 18 in order to restore power to the CFL 20.

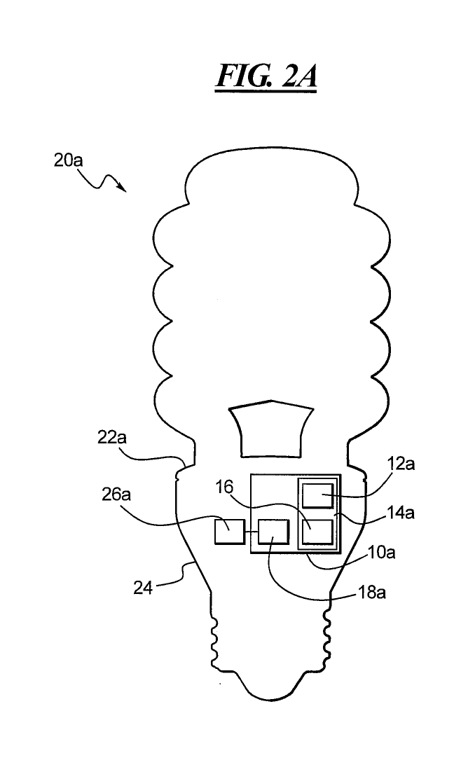

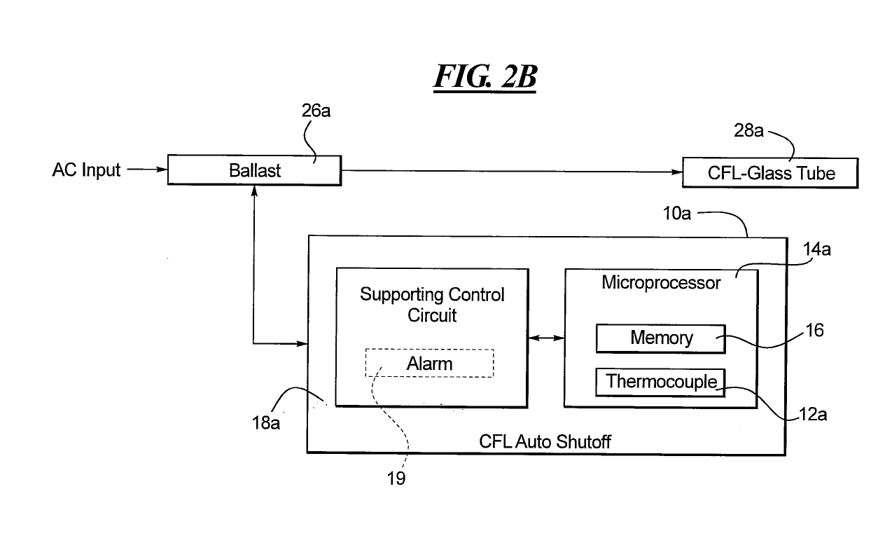

Turning to FIG. 2A, another exemplary auto shutoff 10a is provided for detecting improper use conditions within a typical CFL 20a. As in the previous embodiment, the auto shutoff 10a may be disposed within an enclosure of the CFL 20a defined by a top 22a and a base 24a. Within the enclosure, the auto shutoff 10a may be electrically associated with a ballast 26a responsible for controlling the CFL 20a. The auto shutoff 10a of FIG. 2A may include a temperature transducer 12a, a microcontroller, or microprocessor 14a, a memory 16, and supporting control circuit 18a. As shown in the schematic of FIGS. 2A and 2B, the temperature transducer 12a may be built into the microprocessor 14a for measuring the microprocessor die temperature. Alternatively, the temperature transducer 12a may be external to the microprocessor 14a and linked to an input of the microprocessor 14a.

In the embodiments of FIGS. 2A and 2B, the temperature transducer 12a may measure the internal temperature of the CFL 20a and continuously transmit the temperature information to the microprocessor 14a for further analysis. A predetermined algorithm stored within the memory 16 of the microprocessor 14a may monitor the transmitted information for over-temperature conditions. Upon detection of an over-temperature condition, the algorithm may automatically instruct the microprocessor 14a to execute a shutoff. Specifically, the microprocessor 14a and the supporting control circuit 18a may disable the output of the ballast 26a and therefore turn off the CFL 20a. Once the CFL 20a has been turned off, the algorithm may continue to monitor the information provided by the temperature transducer 12a. If the ambient temperature returns to stable conditions, the algorithm may subsequently instruct the microprocessor 14a to restore power to the CFL 20a.

Still referring to FIG. 2B, the supporting control circuit 18a of the auto shutoff 10a may provide an electrical interface between the auto shutoff 10a and a CFL ballast 26a. Specifically, the supporting control circuit 18a may provide a microprocessor 14a, ASIC, FPGA or any other temperature monitoring circuit, with means for controlling the output of the ballast 26a and/or a proper DC voltage supply. While the ballast 26a may employ AC voltage input to properly drive current through the CFL glass tube 28a, a microprocessor 14a of the auto shutoff 10a may operate only on a specified DC voltage. Accordingly, the supporting control circuit 18a may include a voltage converter to ensure that the microprocessor 14a is supplied with a consistent DC voltage source. As shown in phantom, the supporting control circuit 18a may also incorporate an audible alarm 19 to signal to the user of an improper use, or over-temperature condition.

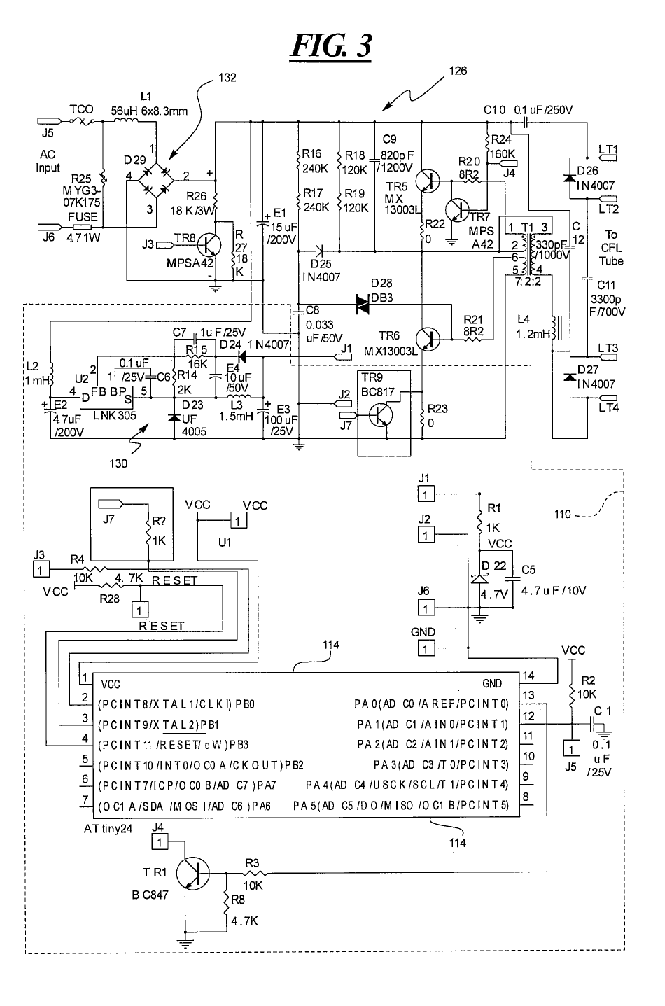

Referring now to FIG. 3, a circuit diagram of an exemplary auto shutoff 110 employing a microprocessor 114 is provided. A typical ballast 126 may be coupled to the output of a rectifier 132, which essentially converts AC input voltage into DC voltage. The ballast 126 may subsequently convert the DC voltage provided by the rectifier 132 into a high frequency AC signal for driving current through a CFL glass tube and thereby illuminating the CFL. The rectifier 132 of FIG. 3 may also provide DC voltage to the auto shutoff 110 and the supporting control circuit with converter 130. The converter 130 may be a DC to DC converter which may convert the DC output provided by the rectifier 132 into a specific DC voltage, or Vcc, required to drive the microprocessor 114. More specifically, node J1 supplies a Vcc source to pin 1 of the microprocessor 114 while node J2 supplies a ground to pin 14.

Still referring to the circuit of FIG. 3, the microprocessor 114 may employ an internal thermocouple to sense and measure the ambient temperature. A predetermined algorithm stored within the memory of the microprocessor 114 may then monitor the temperature information provided by the thermocouple for improper use, or over-temperature conditions. Upon detection of an over-temperature condition, the algorithm may instruct the microprocessor 114 to turn off current to the CFL via supporting control circuit. More specifically, the microprocessor 114 may output a logical HIGH, or 5VDC, on pin 3 to disable current to the CFL glass tube and to turn the CFL off. Subsequently, the algorithm may continue to monitor the temperature for safer conditions. Upon restoration of stable temperatures, the algorithm may instruct the microprocessor 114 to restore current to the CFL glass tube. Specifically, the microprocessor 114 may output a logical LOW, or 0 VDC, on pin 3 to enable the ballast 126 once again. Alternatively, the algorithm may simply turn off power to the CFL until a manual reset is engaged by a user.

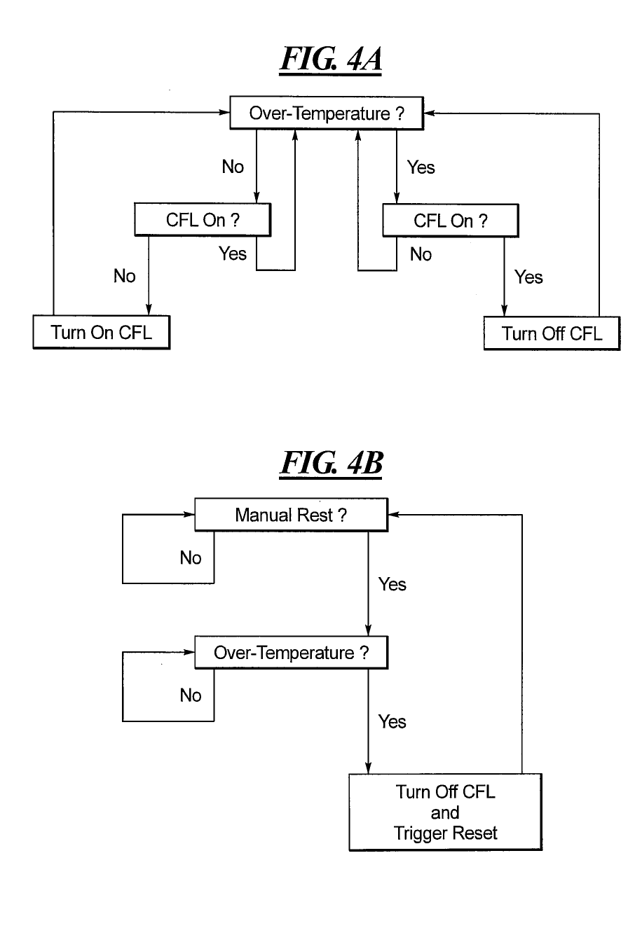

Turning now to FIG. 4A, an exemplary algorithm for operating the microprocessor 114 of FIG. 3 is provided. As previously described, the algorithm may monitor ambient temperature information provided by a thermocouple for over-temperature conditions. More specifically, the algorithm may run as a continuous loop through various conditionals. For instance, the algorithm may initially search for an over-temperature condition. If no over-temperature is detected, the algorithm may check to see if the CFL is currently on. If the CFL is not on, the algorithm may instruct the microprocessor 114 to turn the CFL on. If the CFL is currently on, then the algorithm may leave the CFL on and continue to check for over-temperature conditions. In the event of an over-temperature condition, the algorithm may proceed to check if the CFL is currently on. If the CFL is off, the algorithm may leave the CFL off and continue to monitor the temperature. However, if the CFL is determined to be on, the algorithm may instruct the microprocessor 114 to turn the CFL off. Alternatively, the algorithm may simply turn off power to the CFL until a manual reset is engaged by a user as suggested by FIG. 4B. Additionally, in an embodiment without an algorithm or memory for storing an algorithm, temperature monitoring circuits such as an ASIC, FPGA or the like, may be employed. Such circuits may be constructed and configured specifically to function in the manner of the exemplary algorithms of FIGS. 4A and 4B.

While only certain embodiments have been set forth, alternatives and modifications will be apparent from the above description to those skilled in the art. These and other alternatives are considered equivalents and within the spirit and scope of this disclosure.

What is claimed is:

1. An auto shutoff for a compact fluorescent lamp (CFL), comprising:
an internal thermocouple disposed within a CFL enclosure;
a temperature monitoring circuit linked to the thermocouple; and
a control circuit linked to the temperature monitoring circuit.

2. The device of claim 1, wherein the temperature monitoring circuit is an application specific integrated circuit.

3. The device of claim 1, wherein the temperature monitoring circuit is a microprocessor.

4. The device of claim 1, wherein the temperature monitoring circuit causes the control circuit to shut off the CFL when a temperature detected by the thermocouple exceeds a first predetermined temperature.

5. The device of claim 3, wherein the temperature monitoring circuit causes the control circuit to restore power to the CFL when a temperature detected by the thermocouple is less than a second predetermined temperature.

6. The device of claim 1, wherein the control circuit is also linked to a ballast of the CFL.

7. An auto shutoff for a compact fluorescent lamp (CFL), comprising:
an internal temperature transducer disposed within a CFL enclosure;
a microprocessor linked to the transducer, the microprocessor comprising a memory wherein algorithm is stored; and
a control circuit linked to the microprocessor.

8. The device of claim 7, wherein the temperature transducer is external to the microprocessor.

9. The device of claim 7, wherein the temperature transducer is a thermocouple.

10. The device of claim 7, wherein the algorithm causes the microprocessor and control circuit to shut off the CFL when a temperature detected by the transducer exceeds a first predetermined temperature.

11. The device of claim 10, wherein the algorithm causes the microprocessor and control circuit to restore power to the CFL when a temperature detected by the transducer is less than a second predetermined temperature.

12. The device of claim 7, wherein the control circuit includes at least one audible alarm.

13. The device of claim 7, wherein the control circuit includes a voltage converter.

14. The device of claim 7, wherein the control circuit is also linked to a ballast of the CFL.

15. An auto shutoff for a compact fluorescent lamp (CFL) in improper use conditions, comprising:
an internal temperature transducer disposed within a CFL enclosure;
a microprocessor comprising a memory wherein algorithm is stored, the microprocessor being linked to the temperature transducer and a control circuit, the algorithm causing the microprocessor and control circuit to shut off the CFL when a temperature detected by the temperature transducer exceeds a first predetermined temperature.

16. The device of claim 15, wherein the temperature transducer is a thermocouple.

17. The device of claim 15, wherein the temperature transducer measures a microprocessor die temperature.

18. The device of claim 15, wherein the algorithm causes the microprocessor and control circuit to restore power to the CFL when a temperature detected by the temperature transducer is less than a second predetermined temperature.

19. The device of claim 15, wherein the control circuit includes a voltage converter.

20. The device of claim 15, wherein the control circuit is also linked to a ballast of the CFL.
